(19) United States
(12) Patent Application Publication
(10) Pub. No.: US 2016/0240937 A1
(43) Pub. Date: Aug. 18, 2016

(54) CRIMPING TERMINAL

(71) Applicant: YAZAKI CORPORATION, Tokyo (JP)

(72) Inventor: Takahiro MATSUO, Shizuoka (JP)

(73) Assignee: YAZAKI CORPORATION, Tokyo (JP)

(21) Appl. No.: 15/140,583

(22) Filed: Apr. 28, 2016

Related U.S. Application Data
(63) Continuation of application No. PCT/JP2014/079044, filed on Oct. 31, 2014.

(30) Foreign Application Priority Data
Nov. 5, 2013 (JP) 2013-229135

(51) Int. Cl. H01R 4/18

(52) U.S. Cl. CPC H01R 4/188; H01R 4/185

(57) ABSTRACT

A crimp terminal (10) includes a core wire crimping portion (16) for crimping a core wire (1), the core wire being formed of a plurality of element wires. The core wire crimping portion (16) has a bottom portion (16a), and a swage piece (16b) extended from a side of the bottom portion (16a). The core wire crimping portion (16) is provided with a plurality of protrusions (19) configured to penetrate into the core wire (1).

### CROSS REFERENCE TO RELATED APPLICATIONS

This application is a Continuation of PCT Application No. PCT/JP2014/079044, filed on Oct. 31, 2014, and claims the priority of Japanese Patent Application No. 2013-229135, filed on Nov. 5, 2013, the content of which is incorporated herein by reference.

### BACKGROUND

1. Technical Field

The present invention relates to a crimping terminal to be connected to a wire.

2. Related Art

A conventional crimping terminal of this type includes the one disclosed in JP 2009-123623 A. As shown in FIGS. 1 and 2, a wire W to be connected to a crimping terminal 110 includes a core wire 101 formed of a plurality of element wires 101a and an insulation sheath 102 covering the periphery of the core wire 101. The insulation sheath 102 is removed at the distal end side of the wire W so as to expose the core wire 101.

The crimping terminal 110 has a mating terminal connection portion 111 and a wire connection portion 115. The wire connection portion 115 has a core wire crimping portion 116 and a sheath crimping portion 117. The core wire crimping portion 116 has a bottom portion 116a and a pair of swage pieces 116b extended from both sides of the bottom portion 116a. Three long grooves (serrations) 118 are formed on the inner surface of the bottom portion 116a and the pair of swage pieces 116b of the core wire crimping portion 116. The sheath crimping portion 117 has a bottom portion 117a and a pair of swage pieces 117b extended from both sides of the bottom portion 117a.

The crimping terminal 110 swages and crimps the exposed core wire 101 with the core wire crimping portion 116 and swages and crimps the insulation sheath 102 with the sheath crimping portion 117.

Meanwhile, a wire crimper 120 as shown in FIGS. 3A and 3B is used to swage and crimp the core wire crimping portion 116. The wire crimper 120 has a swage groove 121 having a final swage periphery shape on its distal end side for the swage. As shown in FIGS. 4A and 4B, the pair of swage pieces 116b is pressed by the wire crimper 120 to perform plastic deformation of the pair of the swage pieces 116b.

### SUMMARY OF THE PRESENT INVENTION

As shown in FIG. 4A, the distal end side of the swage piece 116b bite into the core wire 101 at the center portion E1 of the core wire crimping portion 116 in the above swaging process of the core wire crimping portion 116, so that a large compression force acts on the center portion E1. However, a large compression force does not act on a portion outside the center portion E1 of the core wire crimping portion 116. Consequently, a large compression force does not act in a wide range, which cannot generate adhesion in a large range.

Furthermore, as shown in FIG. 4B, the core wire 101 can freely stretch in the right and left axis directions (direction of arrow a, direction of arrow b) in the swaging process of the core wire crimping portion 116. Typically, the core wire 101 located on the distal end side of the swage piece 116b stretches on the distal end side (direction of arrow a), and the core wire 101 located on the rear end side (insulation sheath side) of the swage piece 116b stretches on the rear end side (insulation sheath side) (direction of arrow b).

In this manner, the core wire 101 is free to stretch to reduce its diameter, so that crimping force does not effectively act on each element wire 101a of the core wire 101. The element wire 101a generates a new surface by the stretch but only receives a low pressing force, failing to effectively generate adhesion. Such shortages of the adhesion fails to improve the conductive properties between the element wires 101a, disadvantageously increasing the electrical resistance of the electrical connection portion.

Therefore, the present invention was made to solve the above problems, and an object of the present invention is to provide a crimping terminal capable of reducing the electrical resistance of an electrical connection portion at which a wire is connected.

A crimping terminal according to one aspect of the present invention includes a core wire crimping portion for crimping a core wire, the core wire being formed of a plurality of element wires. The core wire crimping portion has a bottom portion, and a swage piece extended from a side of the bottom portion. The core wire crimping portion is provided with a plurality of protrusions configured to penetrate into the core wire.

The plurality of the protrusions may be symmetrically provided when the core wire is crimped with the core wire crimping portion. A serration may be formed on the inner surface of the core wire crimping portion. The plurality of the protrusions may include at least a pair of protrusions aligned at a height position differing from a height position of the other protrusions.

The crimping terminal according to one aspect of the present invention, the distal end side of the swage piece bites into the core wire at the center portion of the core wire crimping portion, so that a large compression force acts on the center portion in the process of swaging the core wire crimping portion. At this time, a large compression force acts on, via the protrusion, a portion of the core wire crimping portion outside the center portion and below the protrusion. In this manner, a large compression force can act on the core wire in a wide range of the core wire crimping portion. Furthermore, a crimping force acts on the core wire in the process of swaging the core wire crimping portion, which stretches each element wire, generating a new surface. However, the protrusion bites into the core wire, which suppresses the stretch of the core wire by the catching resistance of the protrusion, allowing the compression force to efficiently act on the core wire. That is, a new surface generates due to stretch of each element wire and the compression force efficiently acts on each element wire in a wide range, which generates adhesion, improving the conductive properties between the element wires. This reduces the electrical resistance of the electrical connection portion.

### BRIEF DESCRIPTION OF DRAWINGS

FIG. 1 illustrates a conventional example and is a perspective view of a crimping terminal before a wire is crimped thereby;

FIG. 2 illustrates the conventional example and is a side view of the crimping terminal by which the wire is crimped;

FIG. 3A illustrates a front view of a swaging jig for the conventional example;

FIG. 3B illustrates a side view of the swaging jig for the conventional example;

FIG. 4A illustrates a cross sectional view illustrating a swaging process by the swaging jig for the conventional example;

FIG. 4B illustrates a side view illustrating the swaging process by the swaging jig for the conventional example;

FIG. 5 illustrates an embodiment of the present invention, and is a perspective view of a crimping terminal before a wire is crimped thereby;

FIG. 6A illustrates a side view of the crimping terminal according to the embodiment of the present invention by which the wire is crimpled;

FIG. 6B illustrates a cross sectional view taken along line VIb-VIb of FIG. 6A;

FIG. 7 illustrates the embodiment of the present invention, and is a perspective view of a swaging jig;

FIG. 8 illustrates the embodiment of the present invention, and is a side view illustrating a swaging process by the swaging jig;

FIG. 9A illustrates is a side view of a core wire crimping portion according to a first variation of the embodiment of the present invention; and

FIG. 9B illustrates a side view of a core wire crimping portion according to a second variation of the embodiment of the present invention.

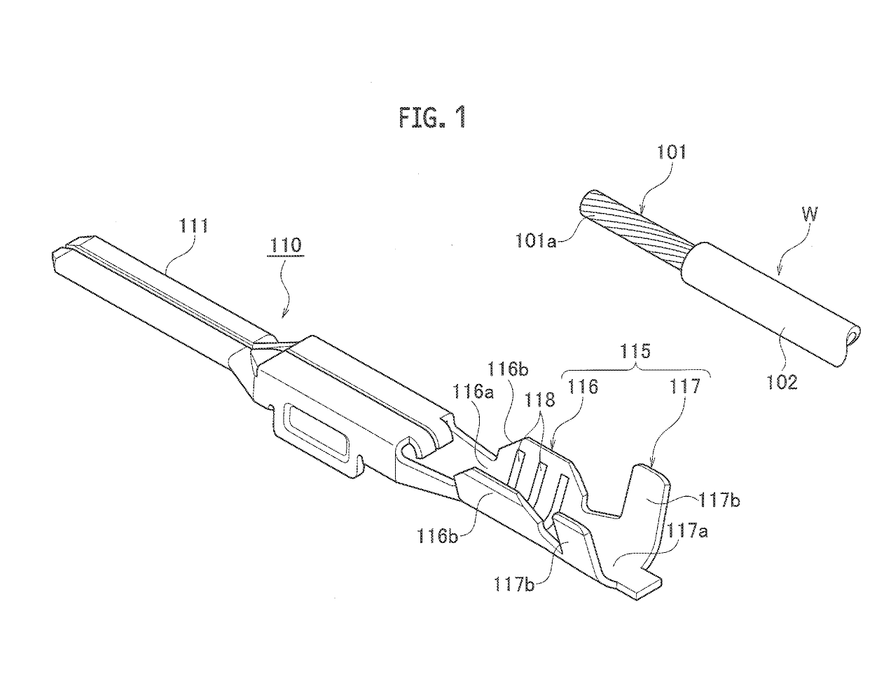

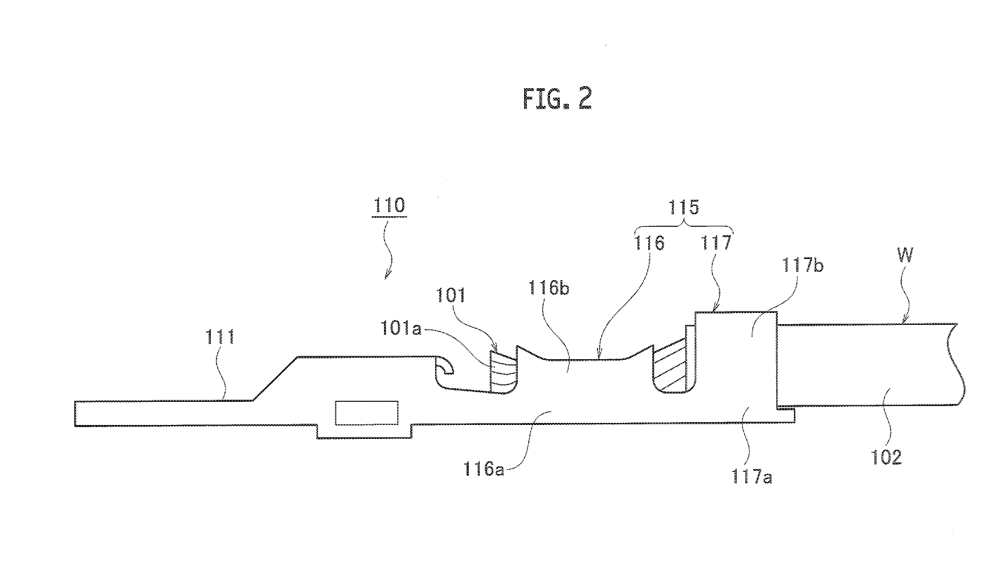

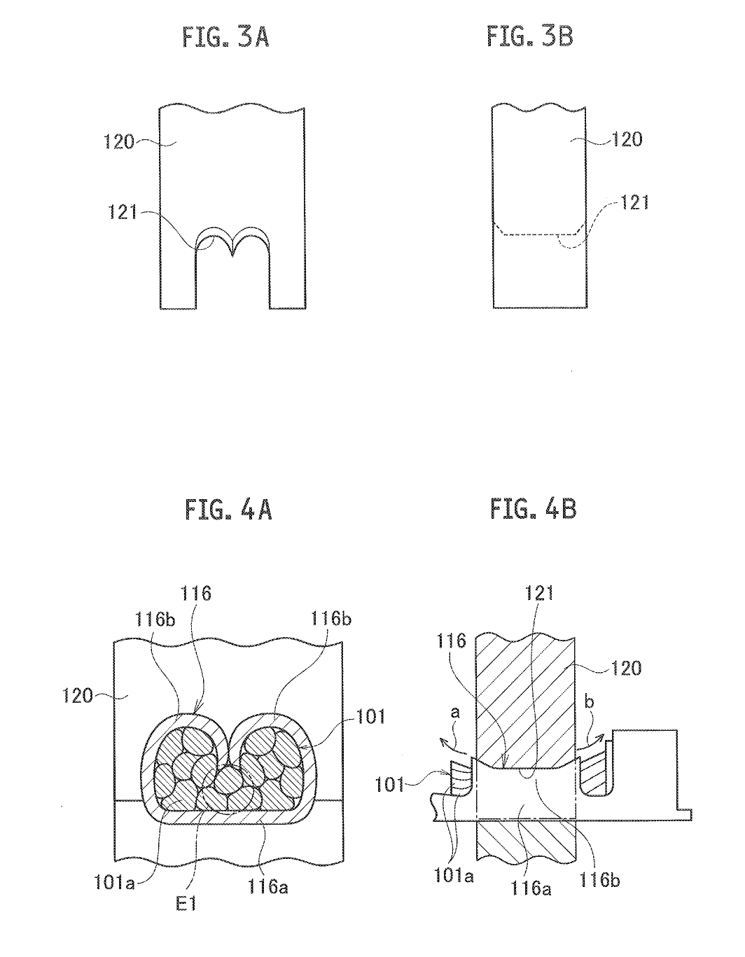

### DETAILED DESCRIPTION

Hereinafter, an embodiment of the present invention will be described based on the drawings.

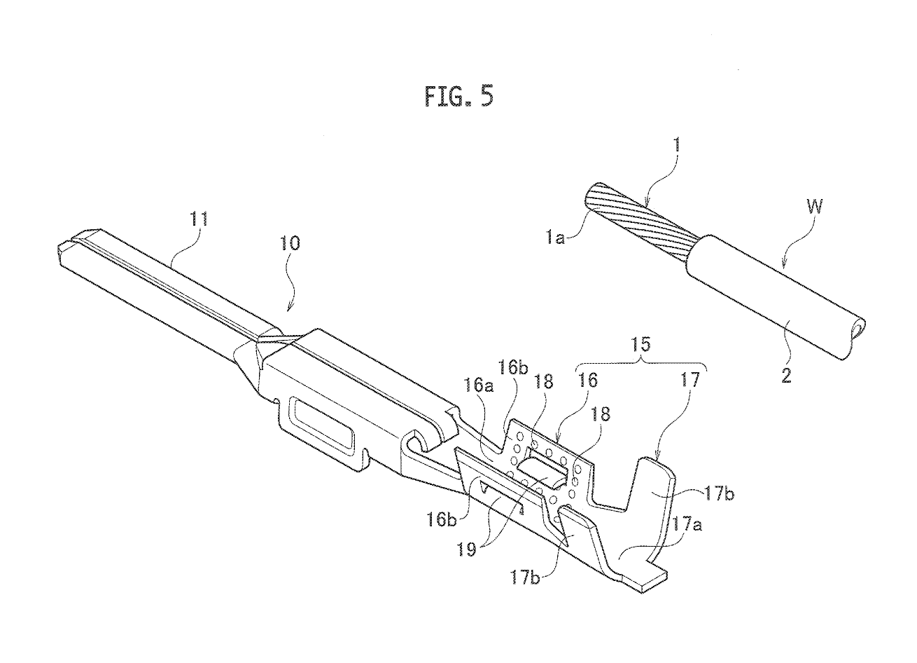

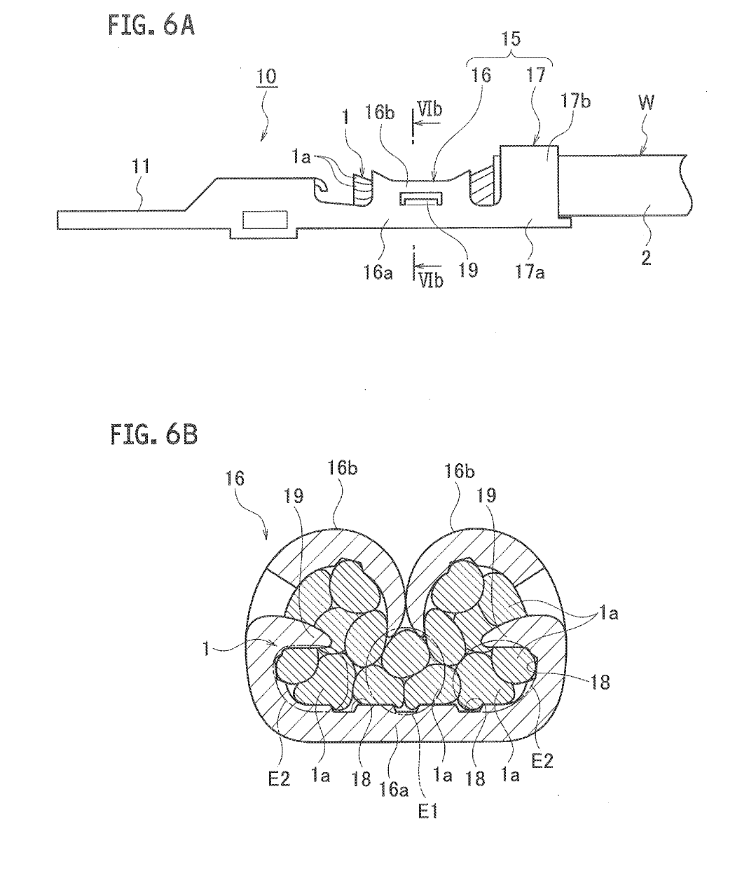

FIGS. 5 to 8 illustrate the embodiment of the present invention. As shown in FIGS. 5 to 6B, a wire W includes a core wire 1 formed of a plurality of element wires 1a, and an insulation sheath 2 covering the periphery of the core wire 1. The insulation sheath 2 is removed at the distal end side of the wire W so as to expose the core wire 1. The core wire 1 is formed of a number of the element wires 1a made of aluminum or aluminum alloy (hereinafter, referred to as aluminum), and a number of the element wires 1a are twisted each other. That is, the wire W is an aluminum wire.

A crimping terminal 10 is made of copper alloy, and is formed by subjecting a plate cut into a predetermined shape to a bending processing. The crimping terminal 10 has a mating terminal connection portion 11 and a wire connection portion 15. The wire connection portion 15 has a core wire crimping portion 16 and a sheath crimping portion 17. The core wire crimping portion 16 has a bottom portion 16a and a pair of swage pieces 16b extended from both sides of the bottom portion 16a.

A number of serrations 18 having a round groove shape are formed on the inner surface of the bottom portion 16a and the pair of swage pieces 16b of the core wire crimping portion 16. Furthermore, protrusions 19 are provided at portions, which are to be left and right side walls of the core wire crimping portion 16 after the core wire is crimped, by cut and raise. The pair of protrusions 19 protrudes toward the space on the side on which the core wire 1 is swaged (inner surface direction of the core wire crimping portion 16 in which the core wire is arranged), and sticks and penetrates into the core wire 1 at the time of crimping the core wire. The pair of protrusions 19 is symmetrically provided. Each protrusion 19 is formed such that its distal end has an edge shape (shape having a thickness reduced toward its distal end).

The sheath crimping portion 17 has a bottom portion 17a and a pair of swage pieces 17b extended from both sides of the bottom portion 17a.

The crimping terminal 10 swages and crimps the exposed core wire 1 with the core wire crimping portion 16, and swages and crimps the insulation sheath 2 with the sheath crimping portion 17.

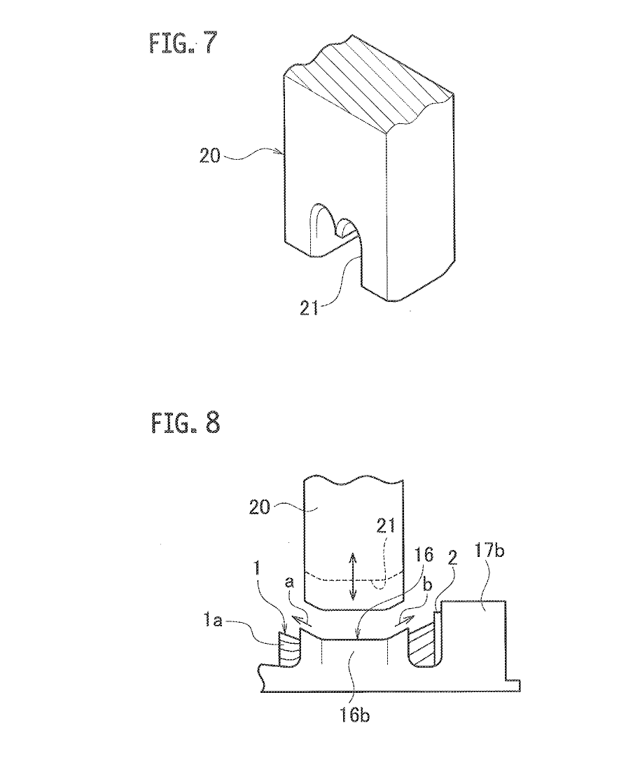

The crimping terminal 10 is crimped by a swaging jig 20 shown in FIG. 7. The swaging jig 20 has a swage groove 21 having a final swage periphery shape on its distal end side for swage. As shown in FIG. 8, when the pair of swage pieces 16b is pressed from the upper direction by the swaging jig 20, the pair of swage pieces 16b is plastically deformed along the swage groove 21.

As shown in FIG. 6B, the distal end sides of the swage pieces 16b bite into the core wire 1 at a center portion E1 of the core wire crimping portion 16, so that a large compression force acts on the center portion E1 in the swaging process of the core wire crimping portion 16. Furthermore, a large compression force acts on, via the protrusion 19, a portion E2 outside the center portion E1 of the core wire crimping portion 16 and below the protrusion 19 (portion sandwiched by a portion that becomes the bottom portion of the core wire crimping portion 16 after the core wire is crimped and the protrusion 19). Consequently, a large compression force acts on the core wire 1 in a wide range.

Furthermore, a crimping force acts on the core wire 1 in the swaging process of the core wire crimping portion 16, so that each element wire 1a stretches to generate a new surface. However, the protrusion 19 penetrates into the core wire 1 arranged in the core wire crimping portion 16, which suppresses the stretch of the core wire 1 in the axis directions (arrow a direction and arrow b direction in FIG. 8) due to the catching resistance of the protrusion 19, allowing the compression force to efficiently acts on the core wire 1. That is, the stretch of each element wire 1a generates a new surface and the compression force efficiently acts on each element wire 1a in a wide range, which generates adhesion, improving the conductive properties between the element wires 1a. This reduces the electrical resistance of the electrical connection portion.

Serrations 18 are provided on the inner surface of the core wire crimping portion 16. The element wire 1a of the core wire 1 is deformed, that is stretched and deformed, to penetrate into the serration 18, so that a new surface is generated, which generates adhesion by receiving a compression force, reducing the conductive resistance between the core wire 1 and the core wire crimping portion 16 and also reducing the conductive resistance between the element wires 1a. This can also reduce the electrical resistance of the electrical connection portion.

The protrusions 19 are symmetrically provided when the core wire is crimped with the core wire crimping portion 16. Thus, the element wires 1a of the core wire 1 can be suppressed to stretch symmetrically, allowing the core wire 1 to be crimped with excellent horizontal balance.

The distal end of the protrusion 19 has the edge shape, so that the protrusion 19 smoothly penetrates into the core wire 1 without bending. Consequently, the electrical resistance of the electrical connection portion due to the protrusion 19 can be stably reduced.

The protrusions 19 are cut and raised at portions that become left and right side walls of the core wire crimping portions 16 after the core wire is crimped. This allows obtaining a stiffening effect of the electrical connection portion, enabling to stably reduce the electrical resistance.

The core wire 1 is made of aluminum. The element wire 1a made of aluminum has an oxide layer thicker than that of the element wire made of copper alloy. Thus, increase of the electrical resistance due to the conductive resistance between element wires 1a was a problem in the core wire 1 made of aluminum. However, the crimping terminal according to the embodiment of the present invention is particularly effective for an aluminum wire, because the conductive resistance between the element wires 1a can be reduced by generation of adhesion. Although the core wire 1 made of aluminum is soft and readily stretched as compared with that made of copper alloy, the stretch of the core wire 1 in the core wire crimping portion 16 can be suppressed to generate adhesion as described above, so that the present embodiment is especially effective for an aluminum wire also from this view point.

### (Variations)

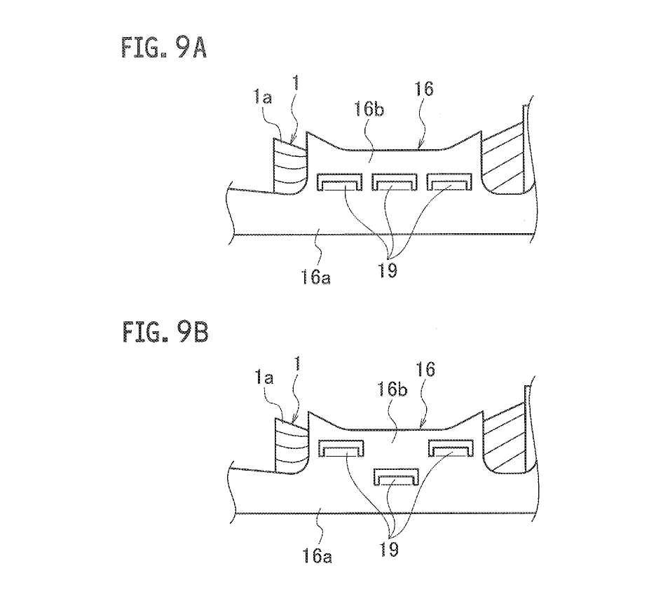

FIG. 9A illustrates a first variation of the core wire crimping portion 16. In the first variation, three protrusions 19 are cut and raised at each of portions that become right and left side walls of the core wire crimping portion 16 after the core wire is crimped. The three protrusions 19 are aligned at the same height.

FIG. 9B illustrates a second variation of the core wire crimping portion 16. In the second variation, similarly to the first variation, three protrusions 19 are out and raised at each of portions that become right and left side walls of the core wire crimping portion 16 after the core wire is crimped. Among the three protrusions 19, the one arranged at the center is provided at the position lower by one step than those arranged at the left and right positions.

Similarly to the above embodiment, the first end second variations can also suppress the stretch of the core wire 1 to allow the compression force to efficiently act on the core wire 1. Therefore, the stretch of each element wire 1a generates a new surface and the compression force efficiently acts on each element wire 1a in a wide range, which generates adhesion, improving the conductive properties between the element wires 1a. This reduces the electrical resistance of the electrical connection portion.

Arrangement pattern, size, the number, and the like of the protrusions 19 are determined in consideration of the catching resistance of the protrusion 19 and the like (suppressing effect of the stretch of each element wire 1a, and the like).

Although the serration 18 is a groove in the embodiment, the serration 18 may be a convexity, or the serrations 18 may include both of a groove and a convexity That is, the serration denotes a groove or a convexity formed on the surface in the description.

Although the core wire 1 is made of aluminum in the embodiment, the core wire 1 made of a material other than aluminum (for example, made of copper alloy) can also be applied to the present invention.

Although the embodiment of the present invention has been described heretofore, the embodiment is merely exemplified for facilitating the understanding of the present invention, and the present invention is not limited to the embodiment. The technical scope of the present invention may include not only the specific technical matters disclosed in the above-described embodiment but also various modifications, changes, and alternative techniques easily derived from the above-described specific technical matters.

What is claimed is:

1. A crimping terminal comprising:
a core wire crimping portion for crimping a core wire, the core wire being formed of a plurality of element wires, the core wire crimping portion having
a bottom portion, and
a swage piece extended from a side of the bottom portion,
wherein the core wire crimping portion is provided with a plurality of protrusions configured to penetrate into the core wire.

2. The crimping terminal according to claim 1, wherein
the plurality of the protrusions is symmetrically provided when the core wire is crimped with the core wire crimping portion,
a serration is formed on the inner surface of the core wire crimping portion, and
the plurality of the protrusions includes at least a pair of protrusions aligned at a height position differing from a height position of the other protrusions.
